(19) United States
(12) Patent Application Publication
(10) Pub. No.: US 2007/0292659 A1
(43) Pub. Date: Dec. 20, 2007

(54) High transmittance touch panel

(75) Inventors: Chia-Yen Li, Taipei County (TW); Pin-Sheng Ho, Taipei County (TW); Sheng-Tsung Chen, Taipei County (TW); Ching-Sheng Yu, Taipei County (TW); Hsiao-Chun Chen, Taipei County (TW); Chia-Chih Chang, Taipei County (TW); Tsung-Chih Huang, Taipei County (TW)

Correspondence Address: BIRCH STEWART KOLASCH & BIRCH, PO BOX 747, FALLS CHURCH, VA, 22040-0747, US

(73) Assignee: DANOTECH CO., LTD.

(21) Appl. No.: 11/453,015

(22) Filed: Jun. 15, 2006

(51) Int. Cl. B32B 5/16; B32B 9/00; B32B 19/00

(52) U.S. Cl. 428/141; 428/212; 428/339; 428/702; 428/323

(57) ABSTRACT

The present invention discloses a high transmittance touch panel, which comprises a substrate and at least one multi-layer anti-reflection coating structure coated on the front side of the substrate. The multi-layer anti-reflection coating structure is a four-layer structure, and the refractive indexes of those layers are high, low, high, and low sequentially from the side neighboring the substrate. The outmost layer is a protective layer having a refractive index within from 1.3 to 1.5 and a thickness of at least 0.1 μm and a hardness reaching 9H of ASTM-D3363. Via the protective layer, not only the transmittance of the touch panel of the present invention can reach over 92% according to ASTM-D1003, but also the abrasion resistance of the touch panel surface can be enhanced.

### FIELD OF THE INVENTION

The present invention relates to a touch panel with a multi-layer anti-reflection coating structure, particularly to a capacitive touch panel with a multi-layer anti-reflection coating structure, which has a protective layer as the surface layer of the multi-layer anti-reflection coating structure to enhance the abrasion resistance thereof.

### BACKGROUND OF THE INVENTION

Traditionally, the anti-reflection coating layer is usually used in building glass and safety goggles. With the evolution of science and technology, the application of this technology has expanded to the fields of semiconductor, reading heads of optical discs, LCD, and touch panels. In the conventional anti-reflection coating technology, the layer directly coated on the substrate has a higher refractive index (denoted by H), and next, a layer having a lower refractive index (denoted by L) is coated on the H layer, and those procedures are repeated once more. Therefore, the refractive indexes of the conventional anti-reflection coating layers are H, L, H, and L from the substrate sequentially.

The US patent of Publication No. 6586101 discloses a technology that a transparent conductive layer is used as the surface layer of the anti-reflection coating layers. The structure of the anti-reflection coating layers of this technology is also a four-layer type, and the refractive indexes of those layers are L, H, L and H from the substrate sequentially. The other conventional technologies have to use ultrasonic welding, which damages the surface layer to reveal the underneath transparent conductive layer. However, this technology is free of ultrasonic welding because the transparent conductive layer is disposed on the outmost layer, and the bottleneck of mass-fabricating anti-reflection coating layers is thus overcome.

In view of those conventional technologies, most of them lay stress on either improving the performance of light transmittance or solving the problem of fabrication. Few of them propose schemes for the abrasion resistance, the stability of light transmittance, and the anti-EMI (ElectroMagnetic Interference) function of the anti-reflection coating layers.

### SUMMARY OF THE INVENTION

The primary objective of the present invention is to provide a high transmittance touch panel, wherein a multi-layer anti-reflection coating structure is coated on the front side of the substrate, and the outmost layer of the multi-layer structure is a protective layer. Thus, the high transmittance touch panel of the present invention not only has a high light transmittance but also has a superior abrasion resistance owing to the protective layer.

Another objective of the present invention is to provide a high transmittance touch panel, wherein another multi-layer anti-reflection coating structure is further coated on the rear side of the substrate in order to further reduce reflection, increase the light transmittance and provide an anti-EMI (ElectroMagnetic Interference) function.

Further another objective of the present invention is to provide a high transmittance touch panel, wherein an anti-glare layer is added into the multi-layer anti-reflection coating structure coated on the front/rear side of the substrate so that the total transmittance can be more stable within the range of the wavelength of visible light.

To achieve the primary objective, the present invention proposes a high transmittance touch panel, which comprises: a substrate and a first anti-reflection coating structure coated on the front side of the substrate. In a preferred embodiment, the first anti-reflection coating structure is a four-layer structure, and the refractive indexes of those layers are high, low, high, and low sequentially from the front side of the substrate. Those four layers are separately denoted by from first to fourth layers. The first layer is an oxide layer having a refractive index greater than 1.5; the second layer is an oxide layer having a refractive index within from 1.3 to 1.5; the third layer is a transparent conductive layer having a refractive index within from 1.8 to 2.5 and an impedance value within from 200 to 10000 ohm/square; and the fourth layer is a protective layer having a refractive index within from 1.3 to 1.5 and a thickness of at least 0.1 μm and a hardness reaching 9H of ASTM-D3363.

To achieve the abovementioned another objective, the present invention proposes a high transmittance touch panel, wherein a second anti-reflection coating structure is coated on the rear side of the substrate. In a preferred embodiment, the second anti-reflection coating structure is a three-layer structure, and the refractive indexes of those layers are high, low, and high sequentially from the rear side of the substrate. Those three layers are separately denoted by from eighth to tenth layers. The refractive index of the eighth layer is identical to that of the first layer, and the refractive index of the ninth layer is identical to that of the second layer; the refractive index of the tenth layer is also identical to that of the third layer and has an impedance value within 10 to 10⁵ ohm/square.

The present invention further proposes a high transmittance touch panel, which has an anti-glare function. In the case that the four-layer anti-reflection coating structure is only coated on the front side of the substrate, the front/rear side of the substrate is roughened with acid dipping or acid etching to obtain an anti-glare effect. Multiple particles may also be added into the outmost layer (the protective layer) to obtain the anti-glare effect. Further, a fifth layer (anti-glare layer) may also be disposed on the surface of the fourth layer or between the third layer and the fourth layer to obtain the anti-glare effect.

The technical contents and preferred embodiments of the present invention are to be described in detail in cooperation with the attached drawings below.

### BRIEF DESCRIPTION OF THE DRAWINGS

FIGS. 1A to 1B are sectional views schematically showing the high transmittance touch panel according to a first embodiment of the present invention.

FIGS. 2A to FIG. 2R are sectional views schematically showing the high transmittance touch panel according to a second embodiment of the present invention.

FIG. 3 is a sectional view schematically showing the high transmittance touch panel according to one form of a third embodiment of the present invention.

FIG. 6 is a sectional view schematically showing the high transmittance touch panel according to another form of a third embodiment of the present invention.

FIGS. 9A to 9B are sectional views schematically showing the high transmittance touch panel according to a fourth embodiment of the present invention.

FIG. 4, FIG. 7, and FIG. 10 to FIG. 12 are diagrams showing the relationship between the transmittance and the wavelength within the range of visible light in the conventional technologies and the present invention.

FIG. 5, FIG. 8, and FIG. 13 to FIG. 15 are diagrams showing the relationship between the reflectivity and the wavelength within the range of visible light in the conventional technologies and the present invention.

FIG. 16 is a diagram showing the total transmittances of the touch panels of the conventional technologies and the present invention, which are tested with the Haze-Gard Plus hazemeter according to ASTM-D1003.

### DETAILED DESCRIPTION OF THE PREFERRED EMBODIMENTS

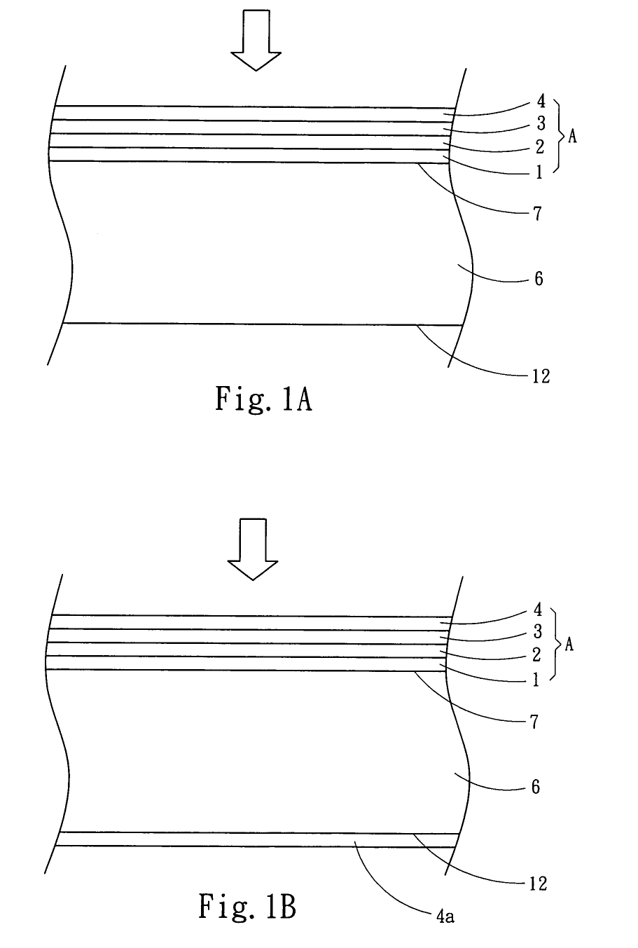

Refer to FIG. 1A a sectional view schematically showing the high transmittance touch panel according to a first embodiment of the present invention. According to the first embodiment of the present invention, the high transmittance touch panel comprises: a substrate 6 and a first anti-reflection coating structure A. The substrate 6 has a front side 7 and a rear side 12, and the front side 7 is defined to be the side neighboring the user, and the rear side 12 is defined to be the side neighboring the backlight source. The substrate 6 may be made of glass, plastic, or another transparent material. The first anti-reflection coating structure A is a four-layer structure and comprises: a first layer 1, a second layer 2, a third layer 3 and a fourth layer 4, which are disposed sequentially from the front side 7 of the substrate 6. Those layers may be formed with a vacuum coating technology, such as sputtering, evaporation, chemical vapor deposition, or other wet coating technologies.

The first layer 1 is an oxide layer having a refractive index greater than 1.5. In this embodiment, the first layer 1 may be made of niobium pentoxide (Nb₂O₅). The material of the first layer 1 may also be selected from the group consisting of ITO (Indium Tin Oxide), ATO (Antimony Tin Oxide), niobium oxide, titanium oxide and tantalum oxide, or be a mixture of those oxides.

The second layer 2 is an oxide layer having a refractive index within from 1.3 to 1.5. In this embodiment, the second layer 2 may be made of silicon oxide (SiO₂). The material of the second layer 2 may also be selected from the group consisting of porous low-refractive-index material, fluorinated low-refractive-index material and organically modified low-refractive-index material.

The third layer 3 is a transparent conductive layer having a refractive index within from 1.8 to 2.5 and an impedance value within from 200 to 10000 ohm/square. In this embodiment, the third layer 3 is connected with the electrode pattern along the perimeter of the touch panel and is made of ITO with an additive—niobium pentoxide (Nb₂O₅). The material of the third layer 3 may also be selected from the group consisting of ATO, pure ITO, tin dioxide (SnO₂), zinc dioxide (ZnO₂), indium oxide (In₂O₃), or be a mixture of those oxides. Whether to add the abovementioned additive niobium pentoxide (Nb₂O₅) depends on requirements, and the concentration of the additive is within from 0.1 to 20%.

The fourth layer 4 is a protective layer having a refractive index within from 1.3 to 1.5 and a thickness of at least 0.1 μm. The fourth layer 4 also has a hardness reaching 9H of ASTM-D3363 and passes at least 1000 strokes of the abrasion test according to MIL-C-675C. In this embodiment, the fourth layer 4 may be made of silicon dioxide or organically modified silica.

Thus, according to the first embodiment of the present invention, a four-layer structure of anti-reflection coating layers is coated on the front side 7 of the substrate 6 of the touch panel, and the refractive indexes of those layers are high, low, high, and low (denoted by H, L H, L) sequentially from the layer neighboring the substrate 6. Thereby, the light transmittance of the touch panel of the present invention can reach over 92% according to ASTM-D1003. Further, as the outmost layer of those layers is defined to be a protective layer, the abrasion resistance of the touch panel of the present invention is enhanced. Another preferred embodiment is shown in FIG. 1B. A protective layer 4a is added on the rear side 12 of the substrate 6 to protect the rear side 12. The material of protective layer 4a is the same as the fourth layer 4.

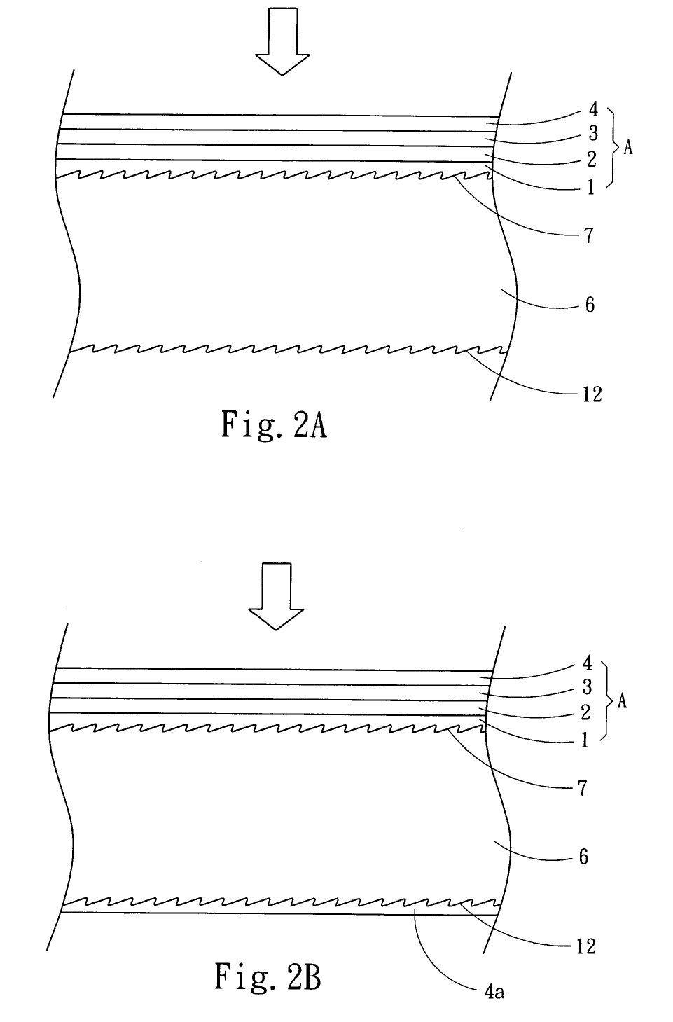

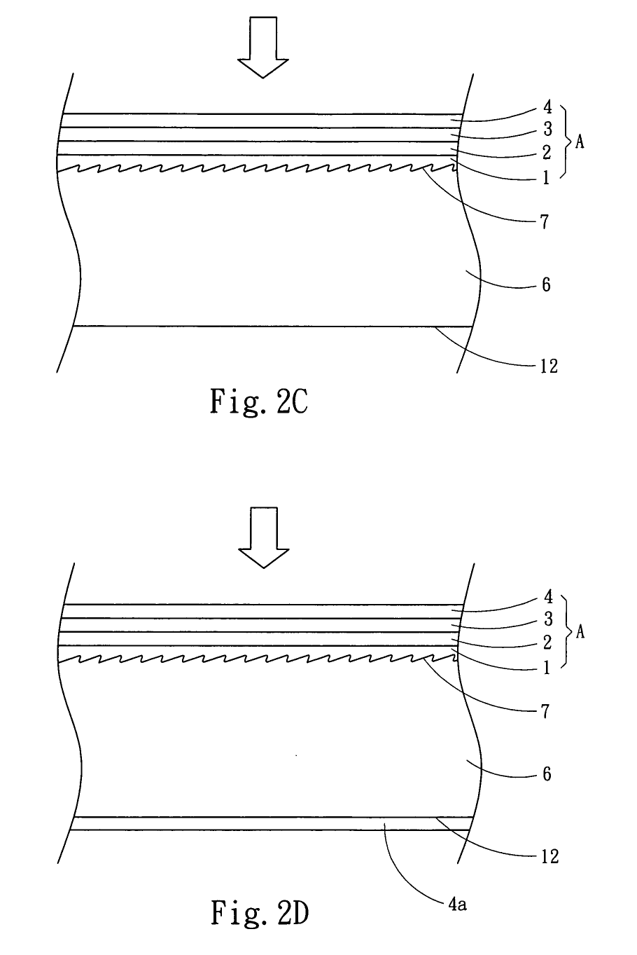

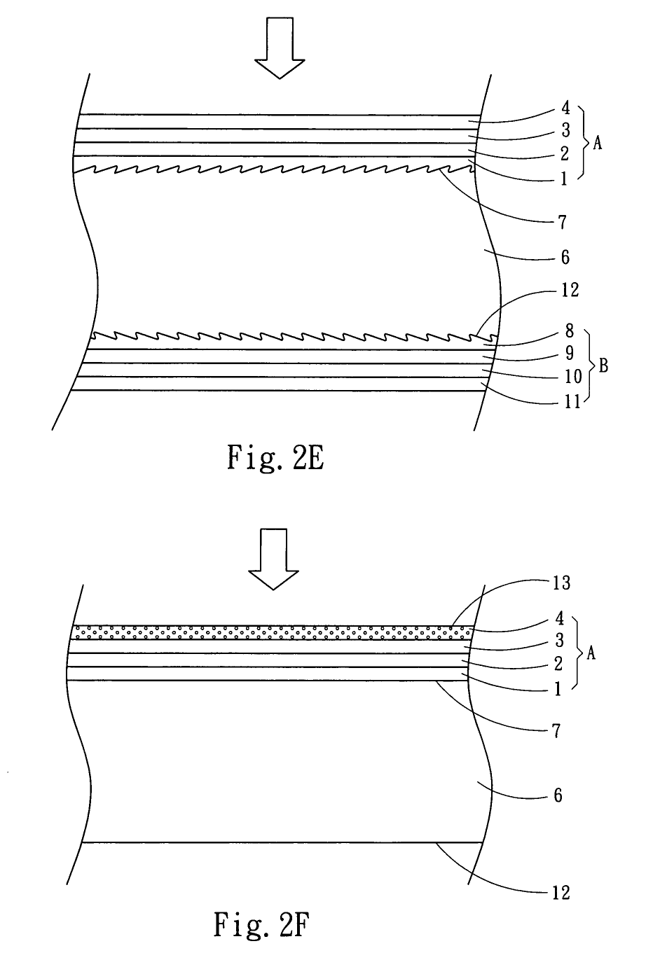

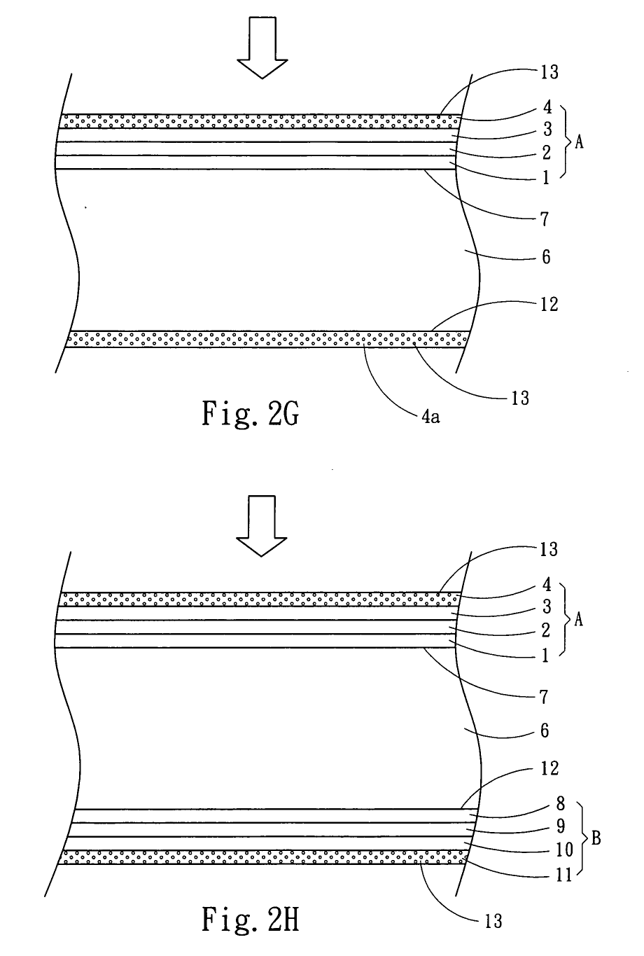

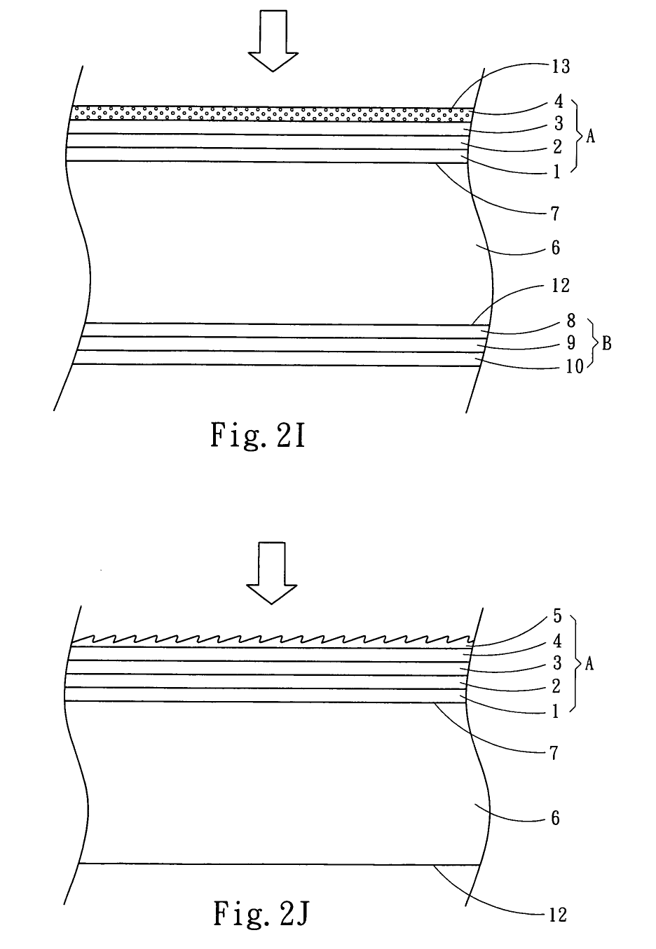

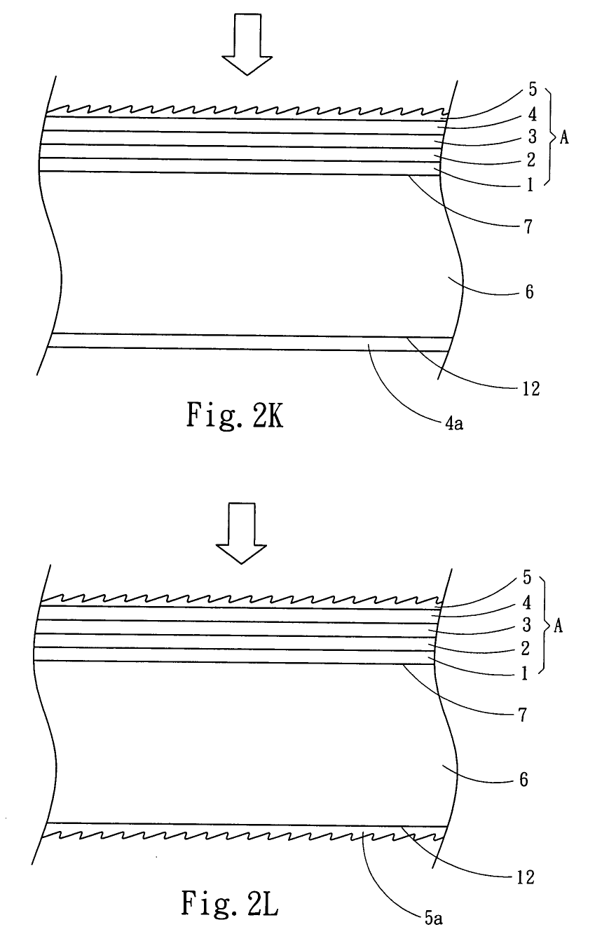

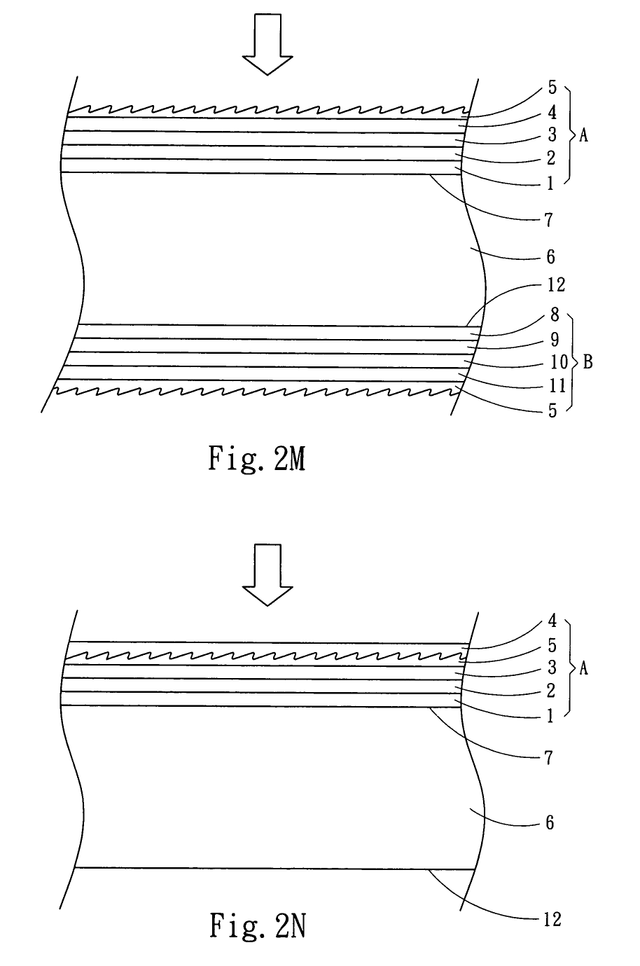

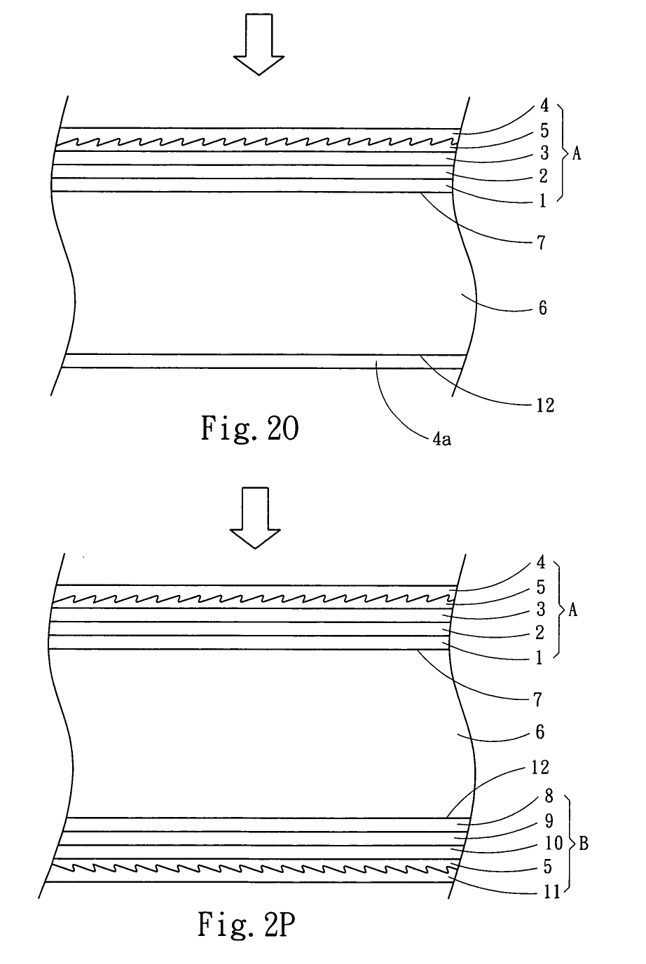

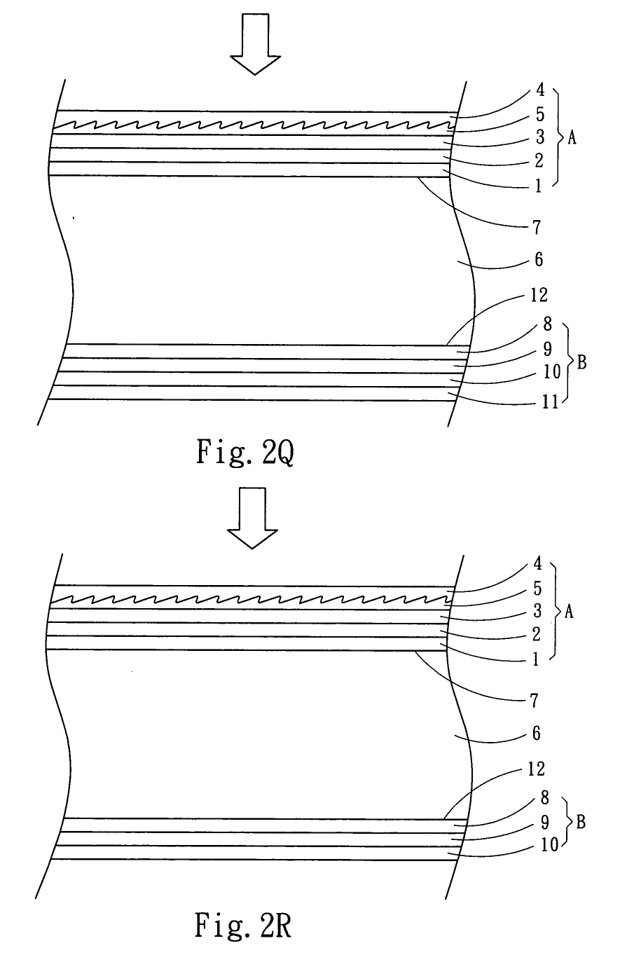

Refer to from FIG. 2A to FIG. 2R sectional views respectively schematically showing five forms of a second embodiment of the present invention. A first form is shown in FIG. 2A. In addition to the abovementioned four-layer anti-reflection coating structure, the front side 7 and the rear side 12 of the substrate 6 are roughened via an acid-dipping method or an acid-etching method in order to obtain an anti-glare effect. This embodiment is not limited to roughening double sides of the substrate 6, and roughening only the user-neighboring front side 7 of the substrate 6 may also work, as shown in FIG. 2C for a second form. A third form is shown in FIG. 2F, multiple particles 13 with the refractive indexes thereof within from 1.3 to 2.5 and the diameters thereof within from 0.01 to 4 μm may be added into the outmost layer (the fourth layer 4) to obtain an anti-glare effect. Further, as shown in FIG. 2J for a fourth form. A fifth layer 5 (an anti-glare layer) may be coated on the fourth layer 4 via a spraying method to roughen the surface of the touch panel with the roughness thereof within from 0.01 to 4 μm; thus, an anti-glare effect is obtained. Another preferred embodiment structure is to form an anti-glare layer 5a on the rear side 12 of the substrate 6 to as shown in FIG. 2L. Furthermore, in this embodiment, it is not necessary after four layers have been formed that the abovementioned fifth layer 5 is to be formed. As shown in FIG. 2N for a fifth form, the fifth layer 5 may be formed on the third layer 3 with a spraying method, and then, the fourth layer 4 is formed on the fifth layer 5.

Another preferred embodiment is based on the structures of FIGS. 2A, 2C, 2F, 2J, and 2N. A protective layer 4a is coated on the rear side 12 having a rough surface as shown in FIGS. 2B, 2D, 2G, 2K, and 20. In FIG. 2G, the protective layer 4a is further added a plurality of particles 13. The particles 13 with the refractive indexes within from 1.3 to 2.5 obtain a better anti-glare effect.

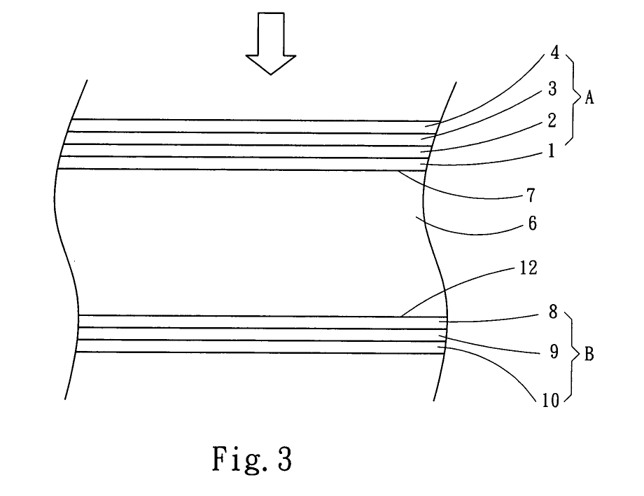

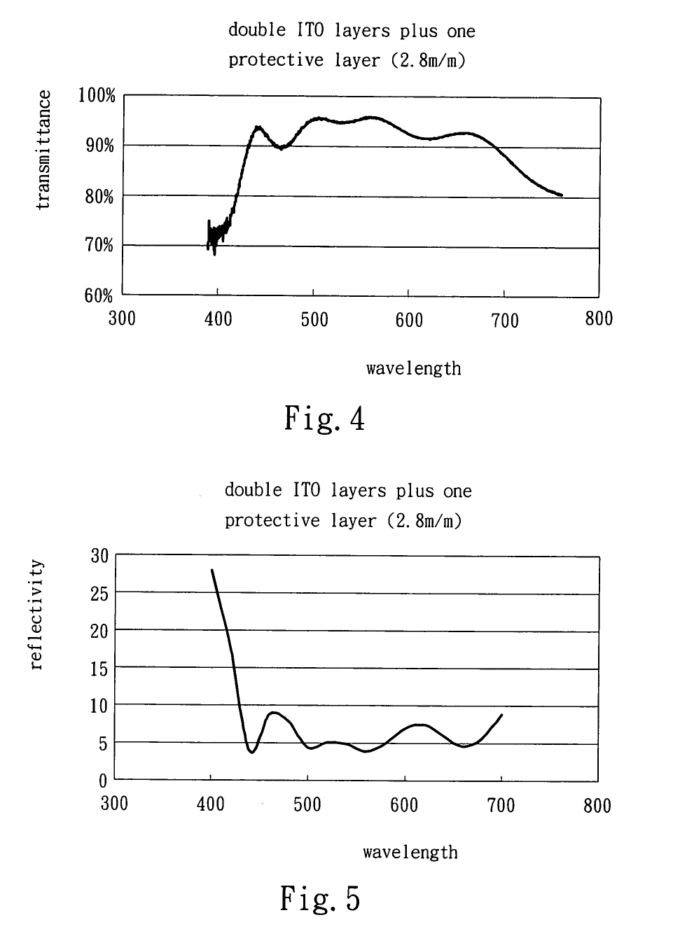

Refer to FIG. 3 for one form of a third embodiment of the present invention. In this embodiment, the rear side 12 of the substrate 6 further has a second anti-reflection coating structure B with mirror structure. The second anti-reflection coating structure B further comprises: an eighth layer 8, a ninth layer 9 and a tenth layer 10, which are disposed sequentially from the rear side 12 of the substrate 6. Those layers may also be formed with a vacuum coating technology, such as sputtering, evaporation, chemical vapor deposition, or other wet coating technologies.

The refractive index of the eighth layer 8 is identical to that of the first layer 1, and the refractive index of the ninth layer 9 is identical to that of the second layer 2. The refractive index of the tenth layer 10 is also identical to that of the third layer 3 and has an impedance value within 10 to 10⁵ ohm/square and connects with the conductor along the perimeter of the touch panel. In this embodiment, the tenth layer 10 may be an ITO layer and has an impedance value within from 100 to 700 ohm/square.

Thus, according to the third embodiment of the present invention, a three-layer structure of anti-reflection coating layers is coated on the rear side 12 of the substrate 6, and the refractive indexes of those layers are high, low, and high (denoted by H, L H) sequentially from the layer neighboring the substrate 6. Thereby, the light reflection of the touch panel can be further reduced, and the light transmittance of the touch panel can be further increased. Furthermore, the tenth layer 10 also has an anti-EMI (ElectroMagnetic Interference) function.

Refer to FIG. 4 and FIG. 5 for the transmittance and the reflectivity of the anti-reflection coating structure of double ITO layers plus one protective layer mentioned above. For the wavelengths within from 431 to 692 nm, the corresponding transmittances are all over 92%. For the wavelengths within from 440 to 700 nm, the corresponding reflectivities are all below 10%.

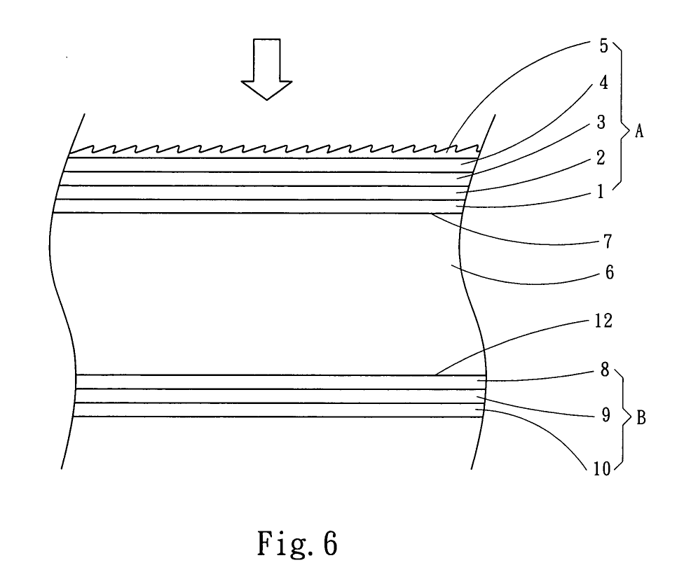

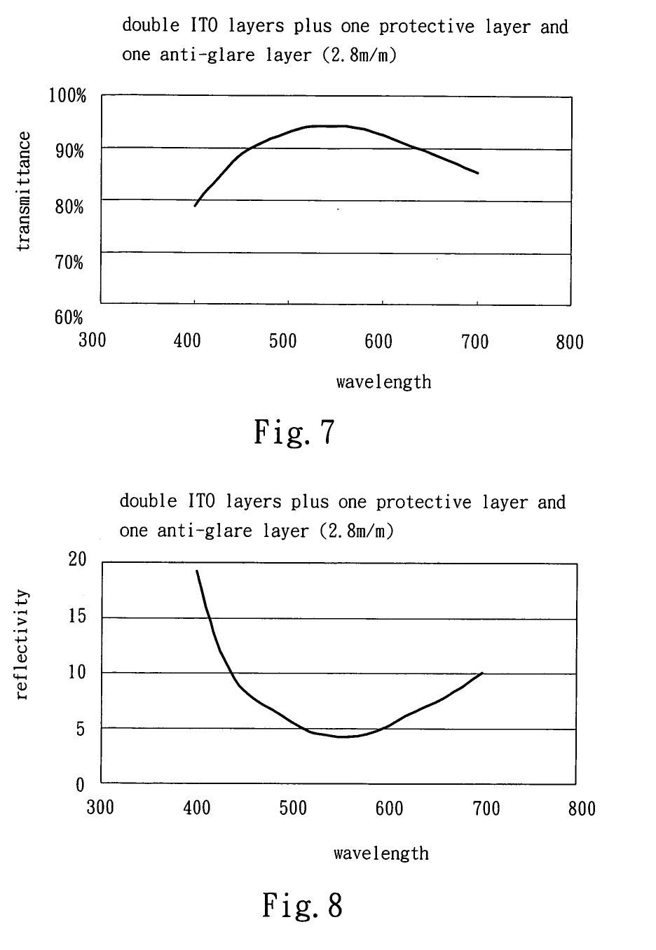

Refer to FIG. 6 for another form of the third embodiment of the present invention. In this form, a fifth layer 5 (an anti-glare layer) is also coated on the fourth layer 4 with a spraying method. Further, the fifth layer 5 may also be disposed between the third layer 3 and the fourth layer 4 (as shown in FIG. 2R).

Refer to FIG. 7 and FIG. 8 for the transmittance and the reflectivity of the anti-reflection coating structure of double ITO layers plus one protective layer and one anti-glare layer (the fifth layer) mentioned above. The portion of the transmittance curve with the transmittance over 90% and the portion of the reflectivity curve with the reflectivity below 10% are both smoothed.

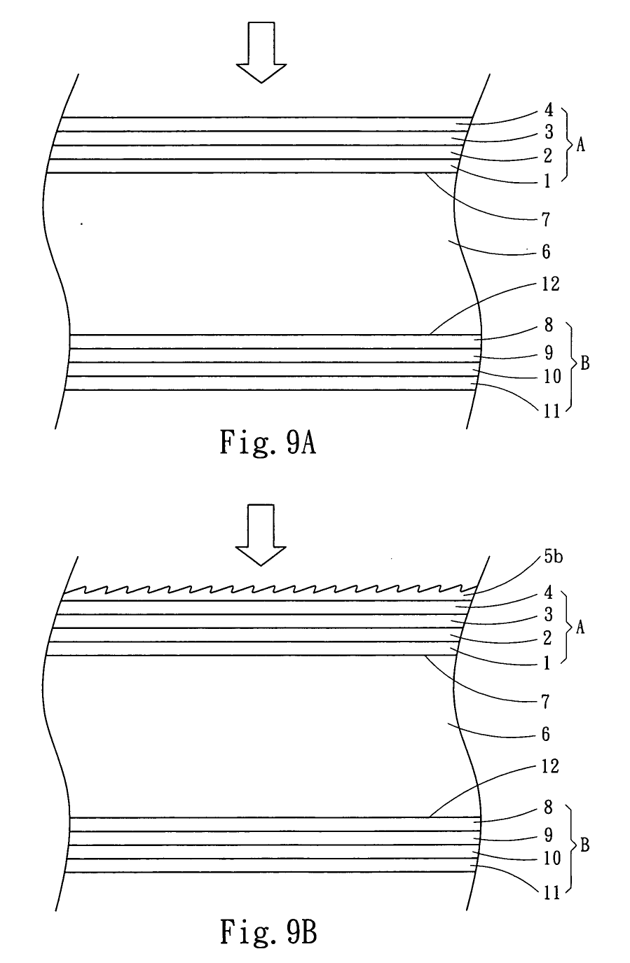

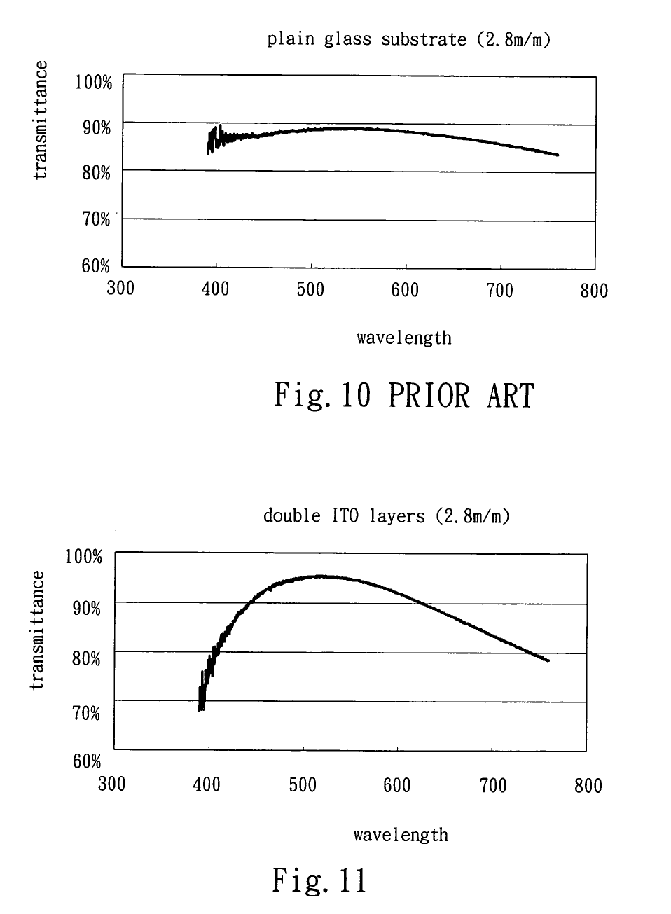

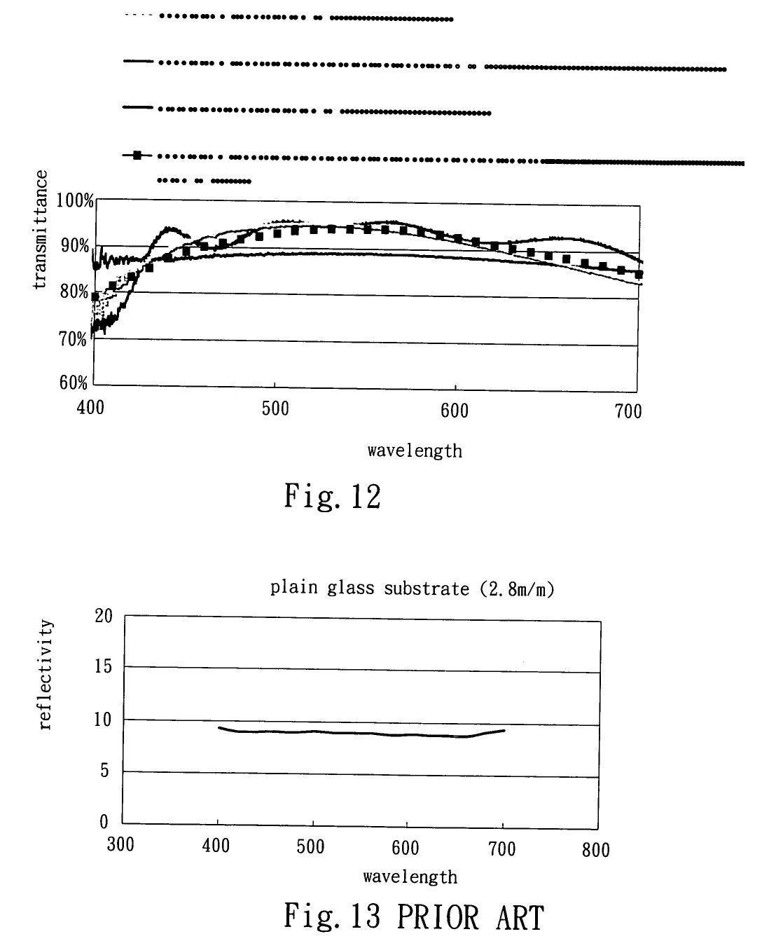

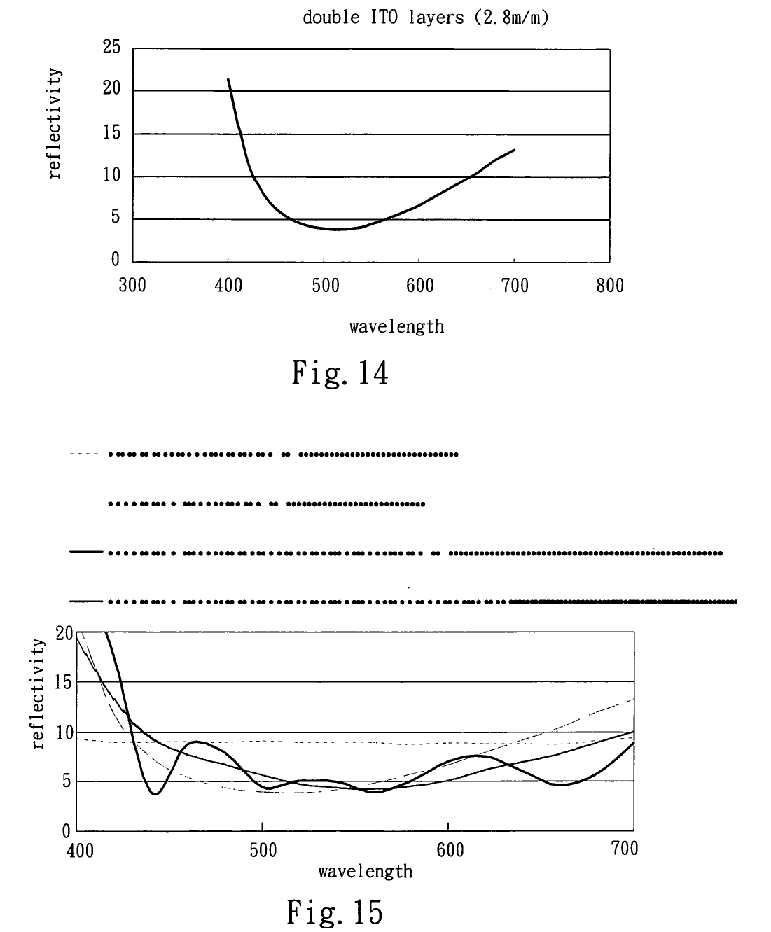

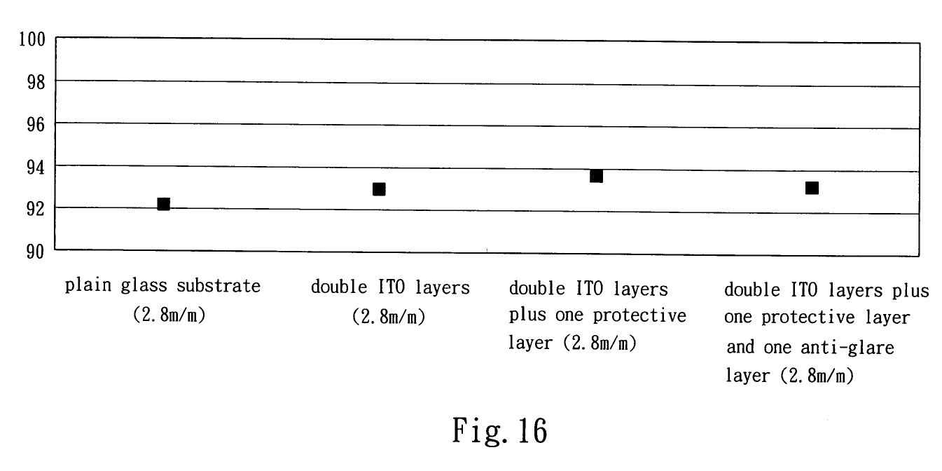

Refer to FIG. 9A for a fourth embodiment of the present invention. In comparison with the third embodiment, the second anti-reflection coating structure B further comprises an eleventh layer 11 in the fourth embodiment. The eleventh layer 11 has a refractive index identical to that of the fourth layer 4 and is a protective layer disposed on the tenth layer 10. Another preferred embodiment structure is further form another anti-glare layer 5b with a rough surface on the surface of the fourth layer 4 of the first anti-reflection coating structure A such that an anti-glare effect can be obtained.

Thus, according to the fourth embodiment of the present invention, the second anti-reflection coating structure B of the touch panel of the present invention may also be a four-layer structure, and further includes the eleventh layer 11 The eleventh layer 11 has a refractive index identical to that of the fourth layer 4 and is a protective layer disposed on the tenth layer 10. The four-layer structure corresponding to the first anti-reflection coating structure (HLHL)A is in mirror symmetry. Thereby, the total transmittance of the touch panel will be more stable within the range of the wavelength of visible light. Similarly, according to the first anti-reflection coating structure A of FIGS. 2C, 2F, 2I, and 2M, the second anti-reflection coating structure B with mirror structure is formed on the rear side 12 of the substrate 6 as shown in FIGS. 2E, 2H, 2M and 2P. Besides, FIG. 2I shows the preferred embodiment based on the structure of FIG. 2H but lacks of the eleventh layer 11 with the plurality of particles 13. In FIG. 2M, the surface of the eleventh layer 11 further forms the fifth layer 5 (anti-glare layer) with a rough surface. In FIG. 2P, the fifth layer 5 (an anti-glare layer) is between the tenth layer 10 and the eleventh layer 11 to provide an anti-glare effect. In addition, FIG. 2Q shows the preferred embodiment based on the structure of FIG. 2P but lacks of the fifth layer 5 (an anti-glare layer). Furthermore, FIG. 2R shows the preferred embodiment based on the structure of FIG. 2P but lacks of the fifth layer 5 (an anti-glare layer) and the eleventh layer 11.

The achievements of the present invention will be further demonstrated below. Firstly, the transmittance is to be compared. As shown in FIG. 10, for the visible-light wavelength within from 380 to 780 nm, the transmittance of a plain glass substrate is within from 80 to 90%. As shown in FIG. 11, for a glass substrate coated with double ITO layers, the transmittance thereof is over 90% for the wavelength within from 442 to 625 nm; however, the transmittance thereof is below 80% for the wavelength smaller than 407 nm or greater than 747 nm. When the abovementioned glass substrate with double ITO layers is further coated with a protective layer of the present invention, the transmittance thereof is increased to over 92% for the wavelength within from 431 to 692 nm, as shown in FIG. 4. In other words, besides increasing abrasion resistance, the protective layer of the present invention also enlarges the portion of the transmittance curve with the transmittance over 92%; thus, the portion of the transmittance curve with the transmittance over 92% in the present invention is greater than that in the conventional glass substrate only with double ITO layers. As shown in FIG. 7, when the fifth layer 5 (an anti-glare layer) is coated on the touch panel, the portion of the transmittance curve with the transmittance over 90% is smoothed; in other words, the display performance of the touch panel is further stabilized thereby. As shown in FIG. 12, the transmittances of all the abovementioned cases are plotted on the same diagram for comparison.

Next, the reflectivity is to be compared. Refer to FIG. 5, and refer to from FIG. 13 to FIG. 15, wherein the Y-axes denote reflectivity. As shown in FIG. 13, for a plain glass substrate, the reflectivity is below 10% for the range of the wavelength of visible light. As shown in FIG. 14, for the glass substrate with double ITO layers, the reflectivity is lowered to below 5% for the wavelength within from 480 to 580 nm, and the reflectivity rises to below 10% for the wavelength below 440 nm or the wavelength over 660 nm. As shown in FIG. 5, for the glass substrate with double ITO layers plus one protective layer of the present invention, the portion of the reflectivity curve with the reflectivity below 10% is enlarged to range from 440 to 700 nm, which is greater than that for the glass substrate with only double ITO layers. As shown in FIG. 8, for the glass substrate with double ITO layers plus one protective layer and the fifth layer (anti-glare layer), the portion of the reflectivity curve with the reflectivity below 10% is smoothed. As shown in FIG. 15, the reflectivities of all the abovementioned cases are plotted on the same diagram for comparison.

Refer to Table 1 and FIG. 16. The total transmittances of the touch panels of the abovementioned cases are measured with the Haze-Gard Plus hazemeter according to ASTM-D1003 (Such a hazemeter is a standard instrument for measuring the total transmittance, the transmittance haze, and clarity of TFT-LCD). It can be seen that the touch panel of the present invention with the glass substrate having one protective layer or one protective layer plus one anti-glare layer is superior to the conventional touch panel with only plain glass substrate or with the glass substrate having double ITO layers.

TABLE 1

| | | | | Glass substrate |
|---|---|---|---|---|
| | | | Glass substrate | with double |
| | | | with double | ITO layers plus |
| | | Glass substrate | ITO layers plus | one protective |
| | Plain glass | with double | one protective | layer and one |
| | substrate | ITO layers | layer | anti-glare layer |
| Substrate | (2.8 m/m) | (2.8 m/m) | (2.8 m/m) | (2.8 m/m) |
| T | 92.2 | 93 | 93.7 | 93.2 |

Those preferred embodiments disclosed above are to clarify the present invention; however it is not intended to limit the scope of the present invention. Although any person skilled in the art is likely to be able to make equivalent modifications or variations according to the spirit of the present invention, any anti-reflection coating structure is to be also included within the scope of the claims of the present invention, which is otherwise designed and formed on the front side 7 and/or the rear side 12 of the substrate 6 according to the principle of the four-layer anti-reflection coating structure disclosed above. Further, the scope of the present depends on the claims stated below.

What is claimed is:

1. A high transmittance touch panel, comprising:
a substrate, having a front side and a rear side opposite to said front side; and
a first anti-reflection coating structure, further comprising: a first layer, a second layer, a third layer, and a fourth layer, wherein said first layer, said second layer, said third layer, and said fourth layer are disposed sequentially from said front side of said substrate; wherein said first layer is an oxide layer having a refractive index greater than 1.5; said second layer is an oxide layer having a refractive index within from 1.3 to 1.5; said third layer is a transparent conductive layer having a refractive index within from 1.8 to 2.5 and an impedance value within from 200 to 10000 ohm/square; and said fourth layer is a protective layer having a refractive index within from 1.3 to 1.5 and a thickness of at least 0.1 μm and a hardness reaching 9H of ASTM-D3363.

2. The high transmittance touch panel according to claim 1, wherein the material of said first layer is niobium pentoxide (Nb₂O₅)

3. The high transmittance touch panel according to claim 1, wherein the material of said first layer is selected from the group consisting of ITO (Indium Tin Oxide), ATO (Antimony Tin Oxide), niobium oxide, titanium oxide, tantalum oxide, and a mixture of those oxides.

4. The high transmittance touch panel according to claim 1, wherein the material of said second layer is silicon dioxide (SiO₂).

5. The high transmittance touch panel according to claim 1, wherein the material of said second layer could be porous low-refractive-index material, fluorinated low-refractive-index material or organically modified low-refractive-index material.

6. The high transmittance touch panel according to claim 1, wherein the material of said third layer is ITO (Indium Tin Oxide) with an additive of niobium pentoxide (Nb₂O₅).

7. The high transmittance touch panel according to claim 1, wherein the material of said third layer is selected from the group consisting of ATO (Antimony Tin Oxide), ITO (Indium Tin Oxide), tin dioxide (SnO₂), zinc dioxide (ZnO₂), indium trioxide (In₂O₃), and a mixture of those oxides.

8. The high transmittance touch panel according to claim 1, wherein the material of said fourth layer is silicon dioxide (SiO₂) or organically modified silica.

9. The high transmittance touch panel according to claim 1, wherein said rear side of said substrate further has a protective layer of said fourth layer.

10. The high transmittance touch panel according to claim 1, wherein said first anti-reflection coating structure further comprises a fifth layer, and said fifth layer is an anti-glare layer disposed on said fourth layer.

11. The high transmittance touch panel according to claim 10, wherein said fifth layer (anti-glare layer) has a rough surface with an average roughness within from 0.01 to 0.4 μm.

12. The high transmittance touch panel according to claim 10, wherein said rear side of said substrate further has a protective layer of said fourth layer or an anti-glare layer of said fifth layer.

13. The high transmittance touch panel according to claim 1, wherein said front and rear sides of said substrate are roughened surfaces.

14. The high transmittance touch panel according to claim 13, wherein said roughened surface of said rear side of said substrate has a protective layer as said fourth layer.

15. The high transmittance touch panel according to claim 1, wherein said front sides of said substrate are roughened surfaces

16. The high transmittance touch panel according to claim 15, wherein said roughened surface of said rear side of said substrate has a protective layer as said fourth layer.

17. The high transmittance touch panel according to claim 1, wherein a plurality of particles with the refractive indexes thereof within from 1.3 to 2.5 are added into said fourth layer.

18. The high transmittance touch panel according to claim 17, wherein said rear side of said substrate has a protective layer as said fourth layer and said plurality of particles with the refractive indexes thereof within from 1.3 to 2.5 are added into said fourth layer.

19. The high transmittance touch panel according to claim 17, wherein the diameters of said particles are within from 0.01 to 0.4 μm.

20. The high transmittance touch panel according to claim 1, further comprising a fifth layer, which is an anti-glare layer disposed between said third layer and said fourth layer.

21. The high transmittance touch panel according to claim 20, wherein said roughened surface of said rear side of said substrate has a protective layer as said fourth layer.

22. The high transmittance touch panel according to claim 20, wherein said rear side of said substrate has a fifth layer, which is an anti-glare layer having a rough surface with an average roughness within from 0.01 to 0.4 μm.

23. The high transmittance touch panel according to claim 20, wherein said rear side of said substrate has a second anti-reflection coating structure which is mirror structure corresponding to said first anti-reflection coating structure of said substrate.

24. The high transmittance touch panel according to claim 1, further comprising a fifth layer, which is an anti-glare layer disposed between said third layer and said fourth layer.

25. The high transmittance touch panel according to claim 18, wherein said rear side of said substrate further has a protective layer of said fourth layer.

26. The high transmittance touch panel according to claim 24, wherein said fifth layer (anti-glare layer) has a rough surface with an average roughness within from 0.01 to 0.4 μm.

27. The high transmittance touch panel according to claim 1, also comprising a second anti-reflection coating structure, which further comprises: an eighth layer, a ninth layer and a tenth layer, which are disposed sequentially from said rear side of said substrate, wherein the refractive index of said eighth layer is identical to that of said first layer, and the refractive index of said ninth layer is identical to that of said second layer; the refractive index of said tenth layer is also identical to that of said third layer and has an impedance value within 10 to 10⁵ ohm/square.

28. The high transmittance touch panel according to claim 27, wherein said front and rear sides of said substrate are roughened surfaces, said second anti-reflection coating structure further comprises a eleventh layer having the same refractive index of said fourth layer, and said eleventh layer is a protective layer disposed on said tenth layer.

29. The high transmittance touch panel according to claim 27, wherein said fourth layer of said front rear side of said substrate has a plurality of particles with the refractive indexes thereof within from 1.3 to 2.5, said second anti-reflection coating structure further comprises a eleventh layer which has the same refractive index of said fourth layer with a plurality of particles, and said eleventh layer is a protective layer disposed on said tenth layer.

30. The high transmittance touch panel according to claim 27, wherein said fourth layer of said front rear side of said substrate is further added a plurality of particles with the refractive indexes thereof within from 1.3 to 2.5

31. The high transmittance touch panel according to claim 27, wherein said tenth layer is an ITO layer and has an impedance value within from 100 to 700 ohm/square.

32. The high transmittance touch panel according to claim 27, wherein said second anti-reflection coating structure further comprising: an eleventh layer, which is a protective layer disposed on said tenth layer and has a refractive index identical to that of said fourth layer.

33. The high transmittance touch panel according to claim 32, further comprising a fifth layer located between said third layer and said fourth layer, said fifth layer being an anti-glare layer located between said ten layer and said eleventh layer.

34. The high transmittance touch panel according to claim 27, further comprising a fifth layer which is an anti-glare layer located between said third layer and said fourth layer.

35. The high transmittance touch panel according to claim 27, further comprising a fifth layer which is an anti-glare layer on said fourth layer.

36. The high transmittance touch panel according to claim 35, wherein said fifth layer (anti-glare layer) has a rough surface with an average roughness within from 0.01 to 0.4 μm.

37. The high transmittance touch panel according to claim 33, said fifth layer (anti-glare layer) has a rough surface with an average roughness within from 0.01 to 0.4 μm.
